(19) United States
(12) Patent Application Publication
(10) Pub. No.: US 2008/0309213 A1
(43) Pub. Date: Dec. 18, 2008

(54) SPARK PLUG FOR INTERNAL COMBUSTION ENGINE

(75) Inventors: Hiroshi YORITA, Anjo-shi (JP); Masamichi SHIBATA, Toyota-shi (JP)

Correspondence Address: NIXON & VANDERHYE, PC, 901 NORTH GLEBE ROAD, 11TH FLOOR, ARLINGTON, VA, 22203, US

(73) Assignees: NIPPON SOKEN, INC., Nishio-city (JP); DENSO CORPORATION, Kariya-city (JP)

(21) Appl. No.: 12/140,654

(22) Filed: Jun. 17, 2008

(30) Foreign Application Priority Data
Jun. 18, 2007 (JP) 2007-160318

(51) Int. Cl. H01T 13/20

(52) U.S. Cl. 313/141

(57) ABSTRACT

In the spark plug, the ground electrode located so as to form a spark discharge gap with the center electrode thereof includes a ground base member fixed to the mounting fitting thereof and an electrode support member connected to the ground base member. The electrode support member has an opposed surface on which a projecting member is mounted so as to face the center electrode across from the spark discharge gap, and a retreating surface continuing the opposed surface and having such a shape as to approach a fore-end of the spark plug with distance from a junction between the projecting member and the opposed surface. The ground electrode further includes an angular portion at each of intersections between its back surface portion on which the electrode support member is provided, and the retreating surface.

### CROSS-REFERENCE TO RELATED APPLICATION

This application is related to Japanese Patent Application No. 2007-160318 filed on Jun. 18, 2007, the contents of which are hereby incorporated by reference.

### BACKGROUND OF THE INVENTION

1. Field of the Invention

The present invention relates to a spark plug for an internal combustion engine used in vehicles, cogeneration systems, gas pressure-feeding pumps, and so forth.

2. Description of Related Art

FIGS. 6, 7A, and 7B show a conventional spark plug 9 disclosed, for example, in Japanese Paten Application Laid-open No. 2006-286469, which is used as means for igniting a gas mixture introduced into a combustion chamber of a vehicle-mounted internal combustion engine. The spark plug 9 includes a center electrode 94 and a ground electrode 95.

The ground electrode 95 includes a ground base member 950 fixed to a mounting fitting 92, and a projecting member 952 mounted on an opposed surface portion 951, which is a surface portion of the ground base member 950 on the side facing the center electrode 94. The ground base member 950 has angular portions 954 at the edges of the opposed surface portion 951. As shown in FIG. 7A, a spark s is generated in a spark discharge gap G between an electrode fore-end portion 940 of the center electrode 94 and the projecting member 952. When the spark s contacts with the gas mixture, a flame is formed.

Generally, in the combustion chamber, the gas mixture is caused to stream near the spark discharge gap G in the direction shown by the arrow g in FIG. 7B, which is roughly perpendicular to the longitudinal direction of the spark plug 9, for the purpose of agitating the gas mixture. The stream drifts the spark s in the lateral direction, and also displaces a spark discharge position (a starting point of the spark s) in the lateral direction. This makes it possible to enlarge a contact area between the spark S and the gas mixture, because the discharge distance of the spark s becomes long.

However, the displacement of the spark discharge position, that is, the displacement of the starting point of the spark s is limited at the angular portion 954. This is because since the electric field strength at the angular portion 954 tends to be large compared to that in other portions, a current easily flows through the angular portion 954. Accordingly, the spark plug 9 has a problem in that the spark discharge distance cannot be made sufficiently long. This makes it difficult to enlarge the contact area between the spark s and the gas mixture. Hence, the conventional spark plug 9 described above cannot have a sufficiently high ignition performance. It may occur that the spark discharge gap G is increased to lengthen the spark discharge distance of the spark s. However, in this case, there occurs another problem in that a required voltage across the spark discharge gap G has to be significantly increased.

### SUMMARY OF THE INVENTION

The present invention provides a spark plug for an internal combustion engine comprising:

a mounting fitting formed with a mounting thread at a periphery thereof;

an insulator held by the mounting fitting such that a fore-end portion thereof protrudes from the mounting fitting in a first direction;

a center electrode held by the insulator such that a fore-end portion thereof protrudes from the insulator in the first direction; and

a ground electrode located so as to form a spark discharge gap with the center electrode;

the ground electrode including:

a ground base member fixed to the mounting fitting;

an electrode support member connected to the ground base member, the electrode support member having an opposed surface opposed to the center electrode;

a projecting member provided on the opposed surface so as to face the center electrode across from the spark discharge gap; and

a back surface portion on which the electrode support member is provided;

the electrode support member further having a retreating surface continuing the opposed surface and having such a shape as to approach a fore-end of the spark plug with distance from a junction between the projecting member and the opposed surface, the ground electrode further including an angular portion at each of the intersections between the back surface portion and the retreating surface.

According to the present invention, a spark plug, which can exhibit excellent ignition performance without increasing a voltage to cause spark discharge to occur in the spark discharge gap thereof, can be obtained.

Other advantages and features of the invention will become apparent from the following description including the drawings and claims.

### BRIEF DESCRIPTION OF THE DRAWINGS

In the accompanying drawings:

FIG. 1 a longitudinal cross-sectional view of a spark plug of a first embodiment of the invention;

FIGS. 2A and 2B are diagrams explaining the operation of the spark plug of the first embodiment;

FIG. 3 is a diagram explaining the operation of a spark plug of a second embodiment of the invention;

FIG. 4 is a diagram explaining the operation of a spark plug of a third embodiment of the invention;

FIG. 5 is a diagram explaining the operation of a spark plug of a fourth embodiment of the invention;

FIG. 6 a longitudinal cross-sectional view of a conventional spark plug; and

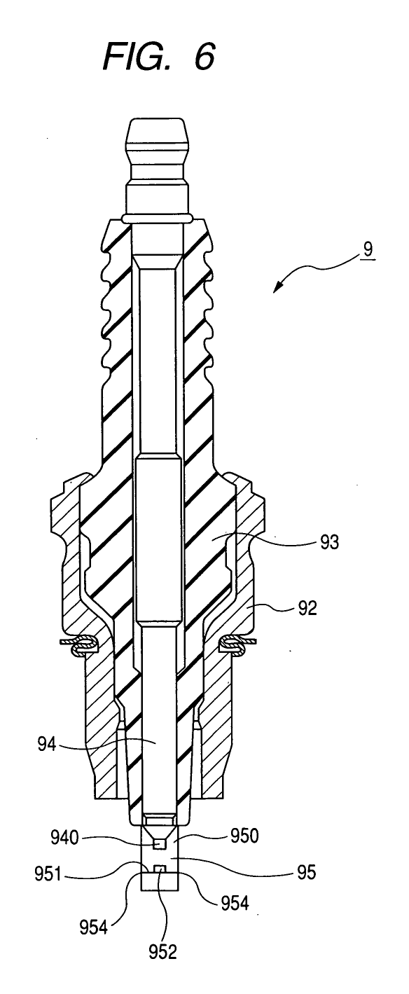

FIGS. 7A and 7B are diagrams explaining the operation of the conventional spark plug.

### PREFERRED EMBODIMENTS OF THE INVENTION

### First Embodiment

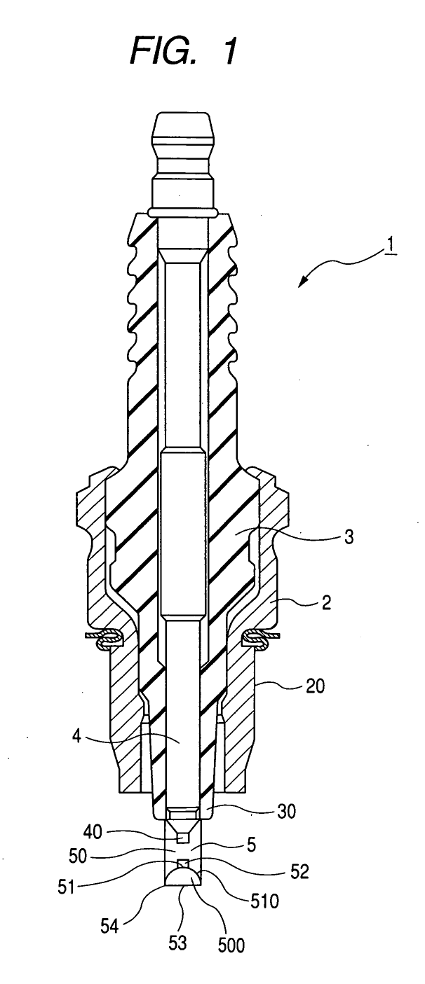

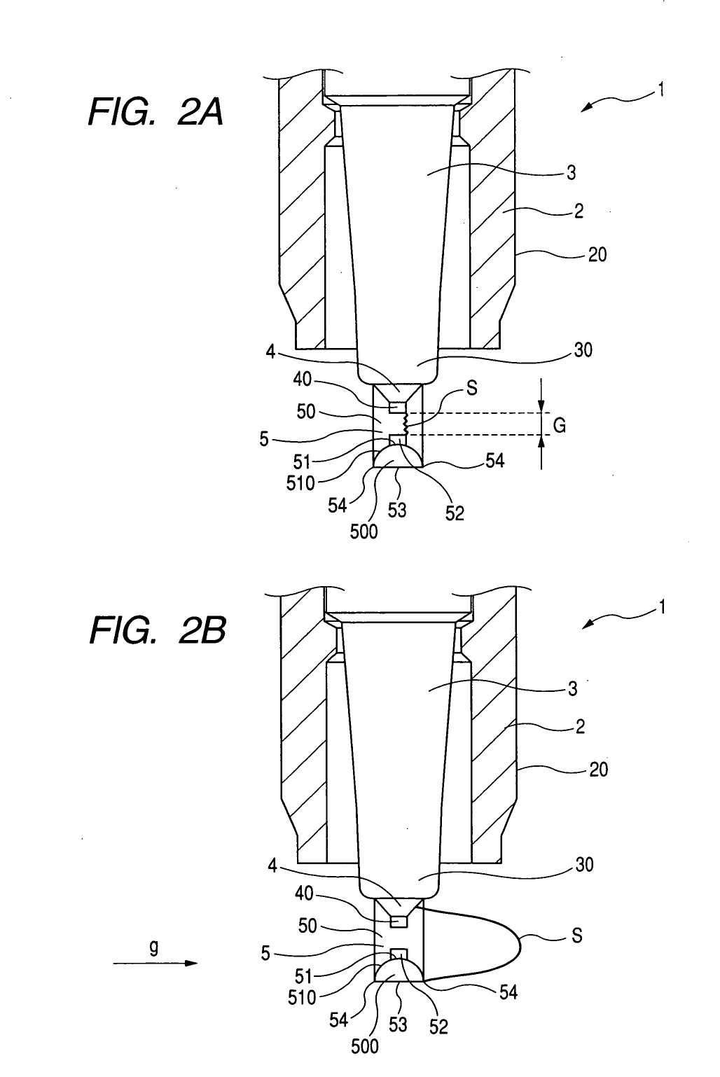

FIG. 1 is a longitudinal cross-sectional view of a spark plug 1 of a first embodiment of the present invention. As shown in FIG. 1, the spark plug 1 includes a mounting fitting 2 formed with a mounting thread 20 at its periphery, an insulator 3 held by the mounting fitting 2 such that a insulator fore-end portion 30 thereof protrudes from the mounting fitting 2, a center electrode 4 held by the insulator 3 such that an electrode fore-end portion 40 thereof protrudes from the insulator fore-end portion 30, and a ground electrode 5 forming a spark discharge gap G with the center electrode 4 (see FIG. 2A).

The ground electrode 5 includes a ground base member 50 fixed to the mounting fitting 2, an electrode support member 500 made of conductive material and having an opposite surface 51 opposed to the center electrode 4, and a retreating surface 510 continuing the opposed surface, a projecting member 52 made of conductive material and mounted on the opposite surface 51, a back surface portion 53 on which the electrode support member 500 is provided. The retreating surface 510 has such a cross section in the direction parallel to FIG. 1 that it approaches the fore-end of the spark plug 9 with distance from a junction between the projecting member 52 and the opposite surface 51.

The ground base member 50 further includes angular portions 54 at positions where the back surface portion 53 and the retreating surface 510 intersect with each other. The electrode support member 500 has a semicircular cross section in the direction parallel to FIG. 1, so that the opposite surface 51 and the retreating surface 510 form a circular-arc outline. The back surface portion 53 has a planar shape.

The spark plug 1 can be used as an ignition means for an internal combustion engine used in vehicles, cogeneration systems, gas pressure-feeding pumps, and so forth. As described above, the spark plug 1 includes the mounting fitting 2 formed with the mounting thread at its periphery. The spark plug 1 is screwed into a wall portion of a combustion chamber of an internal combustion engine (not shown) . One end portion of the ground base member 50 is joined to a fore-end surface of the mounting fitting 2. The ground base member 50 is bent, so that the other end portion thereof forms the back surface portion 53 located in such a position as to be opposite to the center electrode 4. The electrode fore-end portion 40 of the center electrode 4 is made of a metal chip containing noble metal such as Ir, Rh, or Ru.

Next, the operation of the spark plug 1 having the above described structure is explained with reference to FIG. 2A and FIG. 2B. A gas mixture is introduced into the combustion chamber of the internal combustion engine. A stream of the gas mixture in the direction shown by the arrow g in FIG. 2B is generated so that the gas mixture is sufficiently agitated in the combustion chamber. In this state, a voltage is applied between the center electrode 4 and the ground electrode 5, as a consequence of which, as shown in FIG. 2A, a spark S is discharged in the spark discharge gap G between the electrode fore-end portion 40 of the center electrode 4 and the projecting member 52 of the ground electrode 5. At this time, since there exists the stream of the gas mixture in the combustion chamber, the spark S is stretched in the direction along the stream as shown in FIG. 2B. Also, a spark discharge position (starting point of the spark S) is displaced in the direction of the stream of the gas mixture.

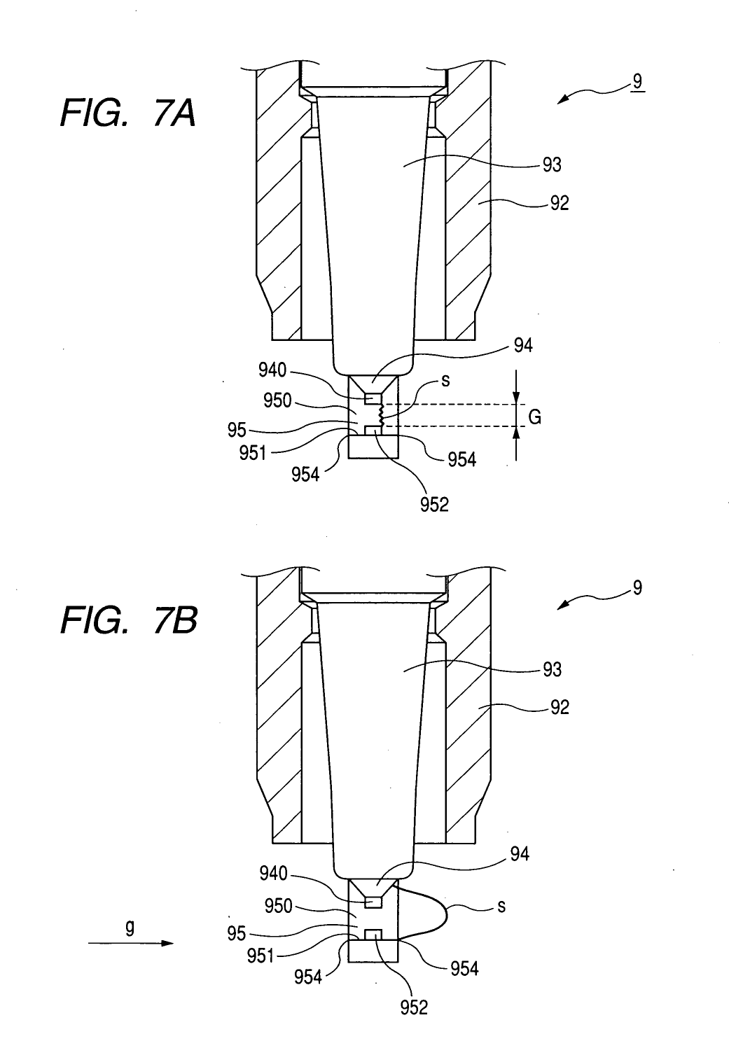

As explained above, the ground base member 50 has the back surface portion 53 and the retreating surface 510 which intersect with each other. The ground base member 50 does not include any angular portion located between the junction with the projecting member 52, and the back surface portion 53. Accordingly, when the spark S is drifted by the stream of the gas mixture, the starting point of the spark S can be displaced along the retreating surface 510 until it reaches the angular portion 52 of the back surface portion 53. This makes it possible to enlarge the spark discharge distance of the spark S, to thereby enlarge the contact area between the gas mixture and the spark S. Accordingly, according to this embodiment, it is possible to enlarge the contact area between the gas mixture and the spark S without increasing the spark discharge gap G (see FIG. 2B and FIG. 7B) . Thus, the spark plug 1 for an internal combustion engine of this embodiment has an excellent ignition performance.

Furthermore, since the spark S can be extended far away from the spark discharge gap G, it becomes easy to generate a flame at a position sufficiently distant from the ground electrode 5. This makes it possible to suppress occurrence of misfire due to the flame contacting the ground electrode 5 and thereby being cooled. In addition, since the discharge distance of the spark S can be made long without increasing the spark discharge gap G between the electrode fore-end portion 40 of the center electrode 4 and the projecting member 52, it is not necessary to increase the required voltage, that is, the voltage required to cause the spark discharge to occur in the spark discharge gap G.

As described above, according to the first embodiment, the spark plug, which can exhibit excellent ignition performance without increasing the required voltage, can be obtained.

### Second Embodiment

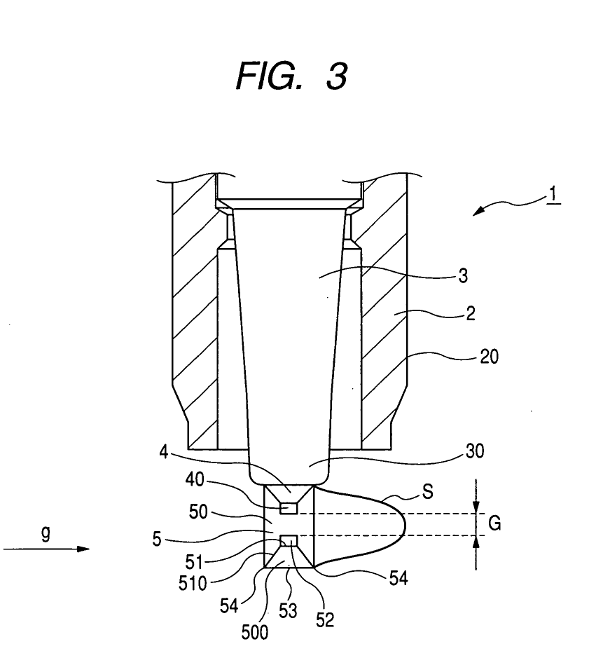

In the second embodiment, as shown in FIG. 3, the electrode support member 500 has a trapezoidal cross section in the direction parallel to FIG. 3.

In this embodiment, since the cross section of the angular portion 54 has an acute angle portion, the electric field strength at the angular portion 54 becomes even stronger compared to the first embodiment, and accordingly the current further easily flows through the angular portion 54. Accordingly, the starting point of the spark S can be further easily displaced to the angular portion 54. Hence, according to the second embodiment, the spark plug for an internal combustion engine having further excellent ignition performance can be obtained. As for the others, the second embodiment is the same as the first embodiment in structure and function.

### Third Embodiment

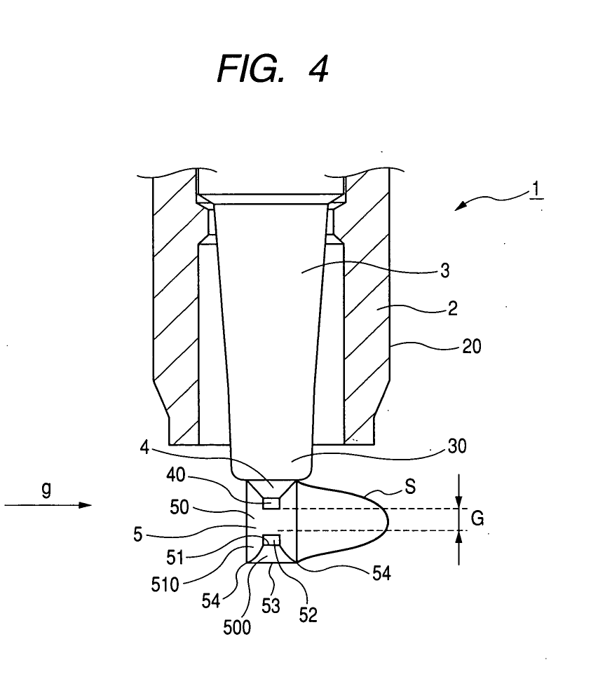

The third embodiment differs from the second embodiment in that the electrode support member 500 has a concaved outline as shown in FIG. 4. Also in this embodiment, the cross section of the angular portion 54 has an acute angle portion. As for the others, the second embodiment is the same as the second embodiment in structure and function.

### Fourth Embodiment

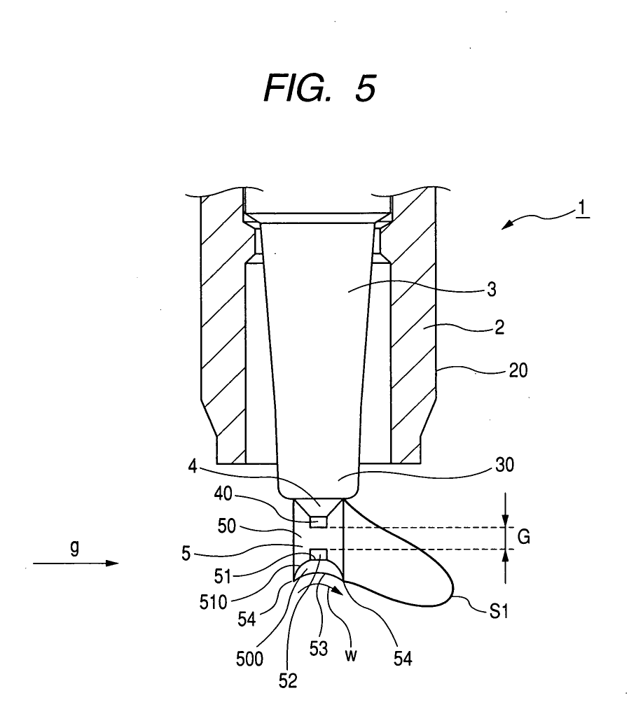

As shown in FIG. 5, the spark plug 1 of the fourth embodiment is characterized in that the back surface portion 53 has a concaved surface as shown in FIG. 5. In more detail, the cross section of the back surface portion 53 in the direction parallel to FIG. 5 has a crescent shape. Also in this embodiment, the cross section of the angular portion 54 has an acute angle portion.

In the fourth embodiment, the stream of the gas mixture along the back surface portion 53, which is shown by the arrow w in FIG. 5, tends to head for the plug fore-end side (the side toward the back of the combustion chamber) at a position near the angular portion 54 in downstream of the swirl. Accordingly, in this embodiment, the spark S1 generated in the spark discharge gap G is drifted not only to the lateral side but also to the plug fore-end side, as a result of which the spark S1 is stretched to a position far away from the wall surface of the combustion chamber. This makes it possible that the spark S1 and the gas mixture sufficiently contact with each other to suppress occurrence of misfire. Accordingly, according to this embodiment, the ignition performance can be further improved. As for the others, the fourth embodiment is the same as the first embodiment in structure and function.

The above explained preferred embodiments are exemplary of the invention of the present application which is described solely by the claims appended below. It should be understood that modifications of the preferred embodiments may be made as would occur to one of skill in the art.

What is claimed is:

1. A spark plug for an internal combustion engine comprising:
a mounting fitting formed with a mounting thread at a periphery thereof;
an insulator held by said mounting fitting such that a fore-end portion thereof protrudes from said mounting fitting in a first direction;
a center electrode held by said insulator such that a fore-end portion thereof protrudes from said insulator in said first direction; and
a ground electrode located so as to form a spark discharge gap with said center electrode;
said ground electrode including:
a ground base member fixed to said mounting fitting;
an electrode support member connected to said ground base member, said electrode support member having an opposed surface opposed to said center electrode;
a projecting member provided on said opposed surface so as to face said center electrode across from said spark discharge gap; and
a back surface portion on which said electrode support member is provided;
said electrode support member further having a retreating surface continuing said opposed surface and having such a shape as to approach a fore-end of said spark plug with distance from a junction between said projecting member and said opposed surface,
said ground electrode further including an angular portion at each of intersections between said back surface portion and said retreating surface.

2. The spark plug according to claim 1, wherein said retreating surface has a curved outline in a cross section thereof in said second direction.

3. The spark plug according to claim 1, wherein said retreating surface portion has a straight outline in a cross section thereof in said second direction.

4. The spark plug according to claim 1, wherein a cross section of each of said angular portion in said second direction has an acute angle portion.

5. The spark plug according to claim 1, wherein a cross section of said back surface portion in said second direction has a concaved outline.
